(19) United States
(12) Patent Application Publication
(10) Pub. No.: US 2026/0211649 A1
(43) Pub. Date: Jul. 23, 2026

(54) METHOD AND SYSTEM FOR PROFILING THREADED PROGRAMS WRITTEN IN INTERPRETED PROGRAMMING LANGUAGES

(71) Applicant: HCL Technologies Limited, New Delhi (IN)

(72) Inventors: Bala Thammana, Chennai (IN); Yogesh Gupta, Noida (IN); Sasikumar Shanmugam, Bengaluru (IN)

(21) Appl. No.: 19/290,473

(22) Filed: Aug. 5, 2025

(30) Foreign Application Priority Data
Jan. 22, 2025 (IN) 202511005114

(51) Int. Cl. G06F 8/41; G06F 11/3604

(52) U.S. Cl. CPC G06F 8/427; G06F 11/3612

(57) ABSTRACT

This disclosure relates to method and system for profiling programs written in interpreted programming languages. The method includes compiling each of a plurality of modified functions in a source code written in an interpreted programming language using a syntax tree of the source code. The method may further include dynamically updating a cache memory with each of the plurality of modified functions using a reflection technique. For each of one or more threads in the source code, the method may further include capturing in run-time profiling insights corresponding to the source code when the source code is executed in the cache memory. The method may further include generating a profiling report including the profiling insights corresponding to the source code.

### DESCRIPTION

### Technical Field

This disclosure relates generally to profiling, and more particularly to method and system for profiling programs written in interpreted programming languages.

### Background

Profiling may be a critical process for optimizing software performance, especially in intepreted programming languages. Resource management and execution speed may often be crucial in the interpreted programming laguages. However, traditional profiling tools may typically focus on isolated functions or specific segments of code such as individual functions or lines. Focusing on the specific segments of code may limit the ability to provide a comprehensive view of overall performance of the application. The traditional profiling tools may limit the effectivenss in complex applications where performance issues may arise from interactions across the entire codebase. The profiling tools may further struggle to effectively analyze code that may run across multiple threads or processes, leading to incomplete performance assessments. Additionally, the profiling may be complicated by circular dependencies. The circular dependecies may make difficult for the profiling tools to trace execution paths and accurately assess performance. The profiling tools may introduce considerable overhead. The overhead may make it hard for the profiling tools to achieve accurate performance metrics for large-scale applications.

Thus, the present invention is directed to overcome one or more limitations stated above or any other limitations associated with the known arts.

### SUMMARY

In one embodiment, a method for profiling programs written in interpreted programming languages is disclosed. In one example, the method may include compiling each of a plurality of modified functions in a source code written in an interpreted programming language using a syntax tree of the source code. Each of the plurality of modified functions is a function modified with a code-profiler. The method may further include dynamically updating a cache memory with each of the plurality of modified functions using a reflection technique. For each of one or more threads in the source code, the method may further include capturing in run-time profiling insights corresponding to the source code when the source code is executed in the cache memory. The profiling insights may include a set of function performance metrics for each of the plurality of modified functions. The profiling insights may further include a set of line performance metrics for each of a plurality of code lines in the each of the plurality of modified functions. The method may further include generating a profiling report including the profiling insights corresponding to the source code.

In one embodiment, a system for profiling programs written in interpreted programming languages is disclosed. In one example, the system may include a processor and a computer-readable medium communicatively coupled to the processor. In one example, the computer-readable medium may store processor-executable instructions, which, on execution, may cause the processor to compile each of a plurality of modified functions in a source code written in an interpreted programming language using a syntax tree of the source code. Each of the plurality of modified functions is a function modified with a code-profiler. The processor-executable instructions, on execution, may further cause the processor to dynamically update a cache memory with each of the plurality of modified functions using a reflection technique. For each of one or more threads in the source code, the processor-executable instructions, on execution, may further cause the processor to capture in run-time profiling insights corresponding to the source code when the source code is executed in the cache memory. The profiling insights may include a set of function performance metrics for each of the plurality of modified functions. The profiling insights may further include a set of line performance metrics for each of a plurality of code lines in the each of the plurality of modified functions. The processor-executable instructions, on execution, may further cause the processor to generate a profiling report including the profiling insights corresponding to the source code.

In one embodiment, a non-transitory computer-readable medium storing computer-executable instructions for profiling programs written in interpreted programming languages is disclosed. In one example, the stored instructions, when executed by a processor, may cause the processor to compile each of a plurality of modified functions in a source code written in an interpreted programming language using a syntax tree of the source code. Each of the plurality of modified functions is a function modified with a code-profiler. The operations may further include dynamically updating a cache memory with each of the plurality of modified functions using a reflection technique. For each of one or more threads in the source code, the operations may further include capturing in run-time profiling insights corresponding to the source code when the source code is executed in the cache memory. The profiling insights may include a set of function performance metrics for each of the plurality of modified functions. The profiling insights may further include a set of line performance metrics for each of a plurality of code lines in the each of the plurality of modified functions. The operations may further include generating a profiling report including the profiling insights corresponding to the source code.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for profiling programs written in interpreted programming languages, in accordance with some embodiments.

FIG. 2 illustrates a functional block diagram of a system for profiling programs written in interpreted programming languages, in accordance with some embodiments.

FIG. 3 illustrates a flow diagram of an exemplary process for profiling programs written in interpreted programming languages, in accordance with some embodiments.

FIG. 4 is a pie chart representing a proportional resource utilization of the plurality of functions in a multi-threaded environment, in accordance with an embodiment.

FIG. 5 is a bar graph representing distribution of time spent by most consuming the plurality of functions, in accordance with an embodiment.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

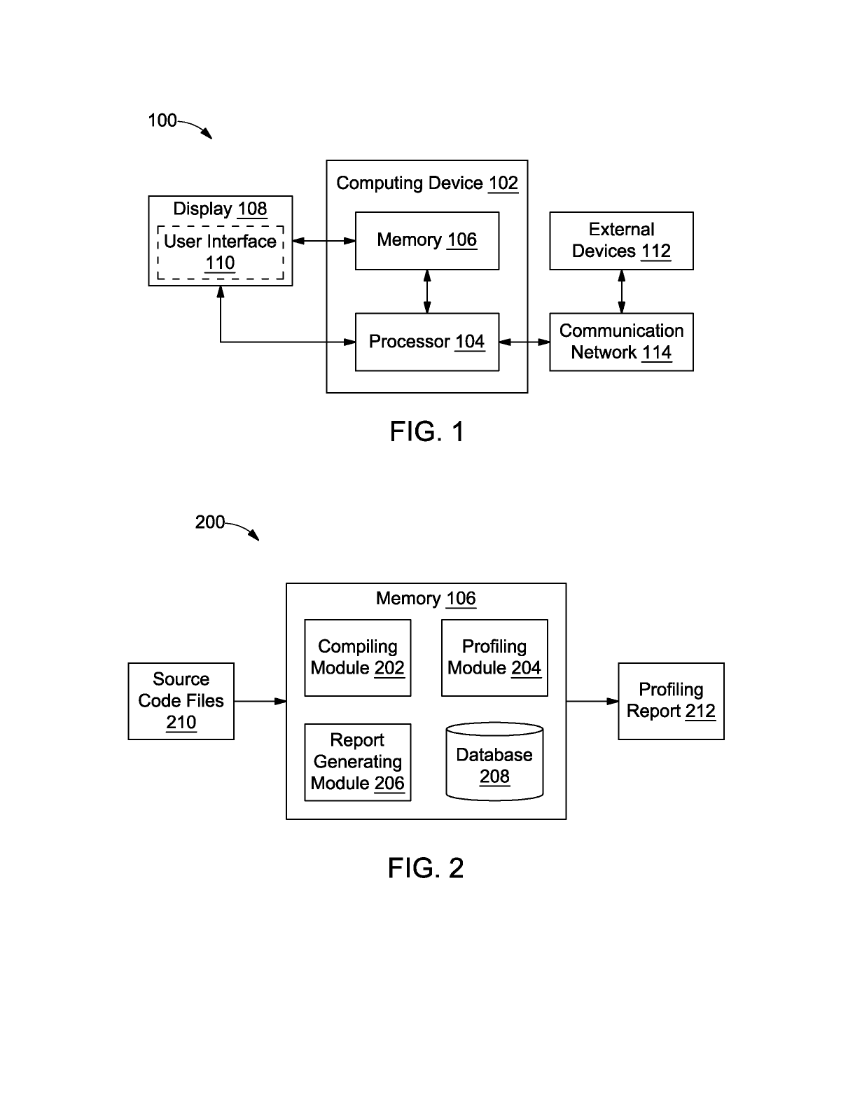

Referring now to FIG. 1, an exemplary system 100 for profiling programs written in interpreted programming languages (for example, Python, JavaScript, Ruby, Perl, PHP, or the like) is illustrated, in accordance with some embodiments. Profiling may be a dynamic program analysis technique to measure various performance metrics (such as memory and time complexity) of a program. The system 100 may include a computing device 102 (for example, a server, a desktop, a laptop, a notebook, a netbook, a tablet, a smartphone, a mobile phone, or any other computing device), in accordance with some embodiments. The computing device 102 may perform profiling of threaded programs written in interpreted programming languages by integrating a static profiling technique and a dynamic profiling technique to capture profiling insights during run-time.

As will be described in greater detail in conjunction with FIGS. 2 - 6, the computing device 102 may compile each of a plurality of modified functions in a source code written in an interpreted programming language using a syntax tree of the source code (a group of instructions a programmer may write using computer programming languages such as Java, Python, etc.). The term “source code” used herein may refer to a codebase constituting the source code of an application. Each of the plurality of modified functions is a function modified with a code-profiler. The computing device 102 may further dynamically update a cache memory with each of the plurality of modified functions using a reflection technique. For each of one or more threads in the source code, the computing device 102 may further capture in run-time profiling insights corresponding to the source code when the source code is executed in the cache memory. The profiling insights may include a set of function performance metrics for each of the plurality of modified functions. The profiling insights may further include a set of line performance metrics for each of a plurality of code lines in the each of the plurality of modified functions. The computing device 102 may further generate a profiling report including the profiling insights corresponding to the source code

In some embodiments, the computing device 102 may include one or more processors 104 and a memory 106. The memory 106 may include a cache memory. The memory 106 may store instructions that, when executed by the one or more processors 104, may cause the one or more processors 104 to profile programs written in interpreted programming languages, in accordance with aspects of the present disclosure. The memory 106 may also store various data (for example, source code files, syntax tree, a plurality of modified functions, profiling report, and the like) that may be captured, processed, and/or required by the system 100.

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram of a system 200 for profiling programs written in interpreted programming languages is illustrated, in accordance with some embodiments. FIG. 2 is explained in conjunction with FIG. 1. The system 200 may be analogous to the system 100. The system 200 may include, within the memory 106, a compiling module 202, a profiling module 204, a report generating module 206, and a database 208.

The compiling module 202 may receive a user selection of a plurality of source code files 210 through a User Interface (UI). The compiling module 202 may compile each of a plurality of modified functions in a source code written in an interpreted programming language using a syntax tree of the source code. It should be noted that the source code may include the plurality of source code files 210. It should be further noted that each of the plurality of modified functions is a function modified with a code-profiler. In some embodiments, the code-profiler may be a custom decorator including a predefined trace function. The predefined trace function may allow monitoring of a plurality of function calls, execution of a plurality of lines, and a plurality of exceptions in real-time.

To compile each of the plurality of functions with the code-profiler, the compiling module 202 may generate a syntax tree of a source code from the plurality of source code files 210 using a parser. The syntax tree may be a graphical representation of the source code using a programming language. By way of an example, the syntax tree may include Abstract Syntax Trees (AST) for Python, Babel for JavaScript, or the like. The syntax tree may include a plurality of functions (modules of the source code to accomplish a specific task). Once the syntax tree is generated, the compiling module 202 may add the code-profiler to each of the plurality of functions in the syntax tree to obtain a modified syntax tree. Further, the compiling module 202 may compile the modified syntax tree into a set of low level programming instructions corresponding to the modified plurality of functions. For example, the compiling module 202 may compile the modified syntax tree into a bytecode.

Once the modified syntax tree is compiled into low level programming instructions, the compiling module 202 may dynamically update a cache memory with each of the plurality of modified functions using a reflection technique. By way of an example, the reflection technique may include a settrace function in Python. The settrace function may be a trace function to be called for a plurality of events during the execution of the source code. In other words, the reflection technique may observe and modify the execution of the plurality of modified functions at run-time and may accordingly update the cache memory at run-time.

Further, for each of one or more threads in the source code, the profiling module 204 may capture in run-time, profiling insights corresponding to the source code when the source code is executed in the cache memory. In other words, the source code may correspond to a single-threaded or a multi-threaded program. The profiling module 204 may iteratively capture in run-time, profiling insights for each thread in the source code when the source code is executed in the cache memory. The profiling insights may include a set of function performance metrics for each of the plurality of modified functions. Additionally, the profiling insights may include a set of line performance metrics for each of a plurality of code lines in the each of the plurality of modified functions. By way of an example, the profiling insights may include details such as file name, function name, line number, thread ID, or the like. Once the profiling insights are captured for each of the one or more threads, the profiling module 204 may map each of the captured profiling insights with an associated function, an associated code line, and an associated thread. Further, the profiling module 204 may store the mapped captured profiling insights in an associative data structure (such as a dictionary or Json). The associative data structure may be stored in the database 208.

Further, the report generating module 206 may generate a profiling report 212 including the profiling insights corresponding to the source code. Further, the report generating module 206 may render the profiling report 212 on the UI. In an embodiment, the profiling report may include one or more graphs or tables based on the captured profiling insights.

It should be noted that all such aforementioned modules 202 – 206 may be represented as a single module or a combination of different modules. Further, as will be appreciated by those skilled in the art, each of the modules 202 – 208 may reside, in whole or in parts, on one device or multiple devices in communication with each other. In some embodiments, each of the modules 202 – 208 may be implemented as dedicated hardware circuit comprising custom application-specific integrated circuit (ASIC) or gate arrays, off-the-shelf semiconductors such as logic chips, transistors, or other discrete components. Each of the modules 202 – 208 may also be implemented in a programmable hardware device such as a field programmable gate array (FPGA), programmable array logic, programmable logic device, and so forth. Alternatively, each of the modules 202 – 208 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for profiling programs written in interpreted programming languages. For example, the exemplary system 100 and the associated computing device 102 may include profiling programs written in interpreted programming languages by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

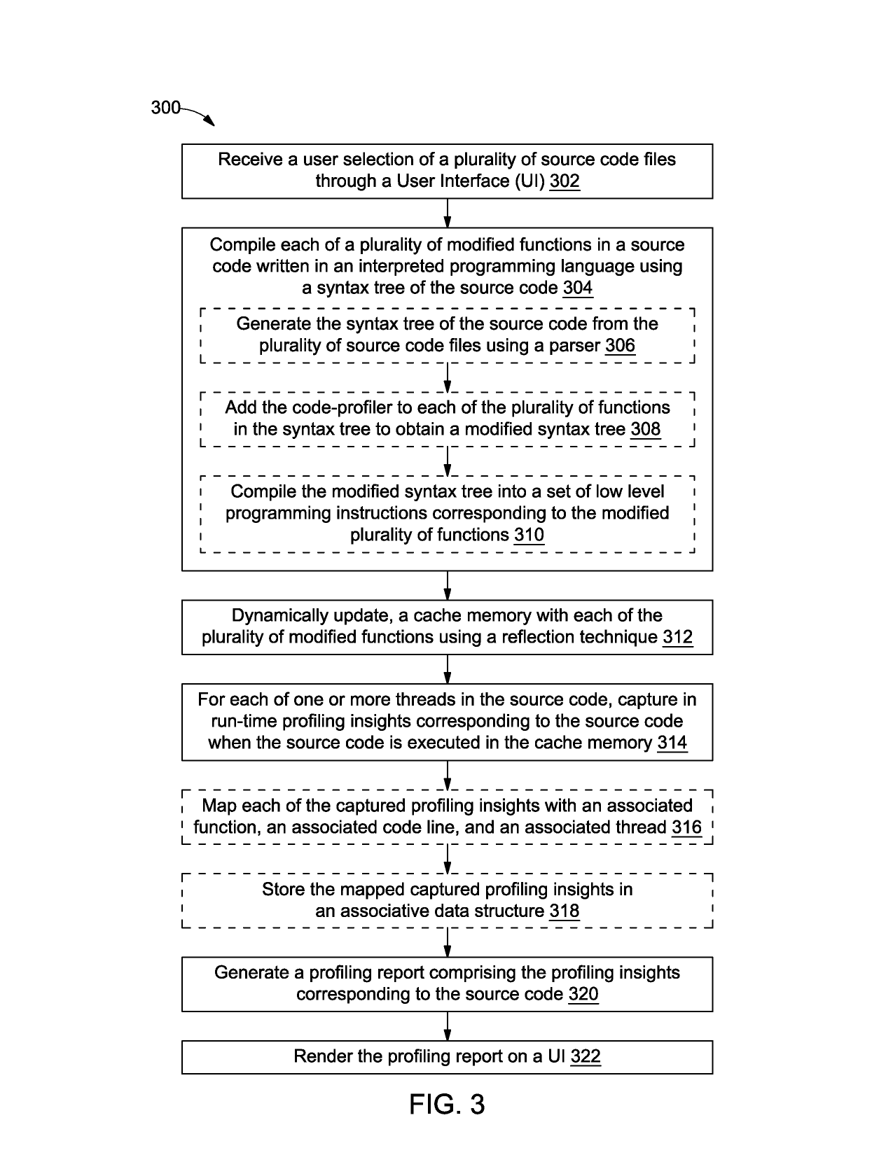

Referring now to FIG. 3, an exemplary process 300 for profiling programs written in interpreted programming languages is depicted via a flowchart, in accordance with some embodiments. FIG. 3 is explained in conjunction with FIGS. 1 and 2. The process 300 may be implemented by the computing device 102 of the system 100. The process 300 may include receiving, by a compiling module (for example, the compiling module 202), a user selection of a plurality of source code files (for example, the source code file 210) through a UI, at step 302. Further, the process 300 may include compiling, by the compiling module, each of a plurality of modified functions in a source code written in an interpreted programming language using a syntax tree of the source code, at step 304. Each of the plurality of modified function is a function modified with a code-profiler. The code-profiler is a custom decorator including a predefined trace function. The step 304 may include the steps 306, 308, and 310. The process 300 may include generating, by the computing module, the syntax tree of the source code from the plurality of source code files using a parser, at step 306. The syntax tree may include a plurality of functions. By way of an example, if the received source code files are in Python language, process 300 may include parsing, the compiling module 202, the source code file to create an AST. The AST may include a plurality of functions. Further, the process 300 may include adding, by the computing module, the code-profiler to each of the plurality of functions in the syntax tree to obtain a modified syntax tree, at step 308. Further, the process 300 may include compiling, by the compiling module, the modified syntax tree into a set of low level programming instructions corresponding to the modified plurality of functions, at step 310. In continuation of the above example, the process 300 may include adding, by the compiling module 202, the code profiler for each of the plurality of function in the AST to obtain a modified AST. Once the code-profiler is added, the process 300 may include compiling the modified AST to bytecode.

Once the modified syntax tree is compiled into a set of low level programming language, the process 300 may include dynamically updating, by the compiling module, a cache memory with each of the plurality of modified functions using a reflection technique, at step 312. The reflection techniques may include, but may not be limited to settrace in Python, Proxy in JavaScript. Further, for each of one or more threads in the source code, the process 300 may include capturing in run-time, by a profiling module (for example, the profiling module 204), profiling insights corresponding to the source code when the source code is executed in the cache memory, at step 314. The profiling insights may include a set of function performance metrics for each of the plurality of modified functions. The profiling insights may further include a set of line performance metrics for each of a plurality of code lines in the each of the plurality of modified functions. In other words, the process 300 may include capturing, the profiling module 204, details such as file name, function name, line number, and thread ID corresponding to the source code. Further, the process 300 may include mapping, by the profiling module, each of the captured profiling insights with an associated function, an associated code line, and an associated thread, at step 316. The process 300 may include storing, by the profiling module, the mapped captured profiling insights in an associative data structure, at step 318. Further, the associative data structure may be stored in the database (for example, the database 208).

Further, the process 300 may include generating, by a report generating module (for example, the report generating module 206), a profiling report (for example, the profiling report 212) including the profiling insights corresponding to the source code, at step 320. Further, the process may include rendering, by the report generating module, the profiling report on an UI, at step 322.

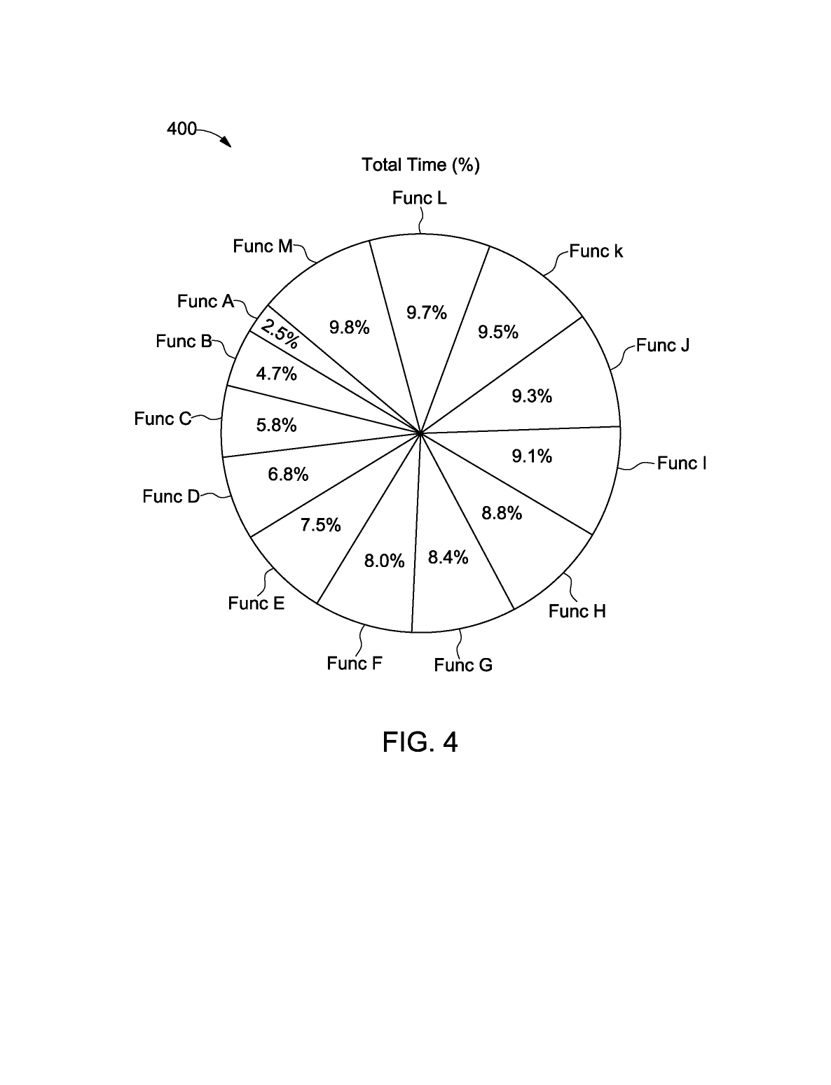

Referring now to FIG. 4, a pie chart 400 representing a proportional resource utilization of the plurality of functions in a multi-threaded environment is illustrated, in accordance with an embodiment. FIG. 4 is explained in conjunction with FIGS. 1, 2, and 3. The pie chart 400 may be obtained from a report generating module (for example, the report generating module 206). The pie chart 400 may include a plurality of functions. By way of an example, the plurality of functions may include, but may not be limited to, function A, function B, function C, function D, function E, function F, function G, function H, function I, function J, function K, function L, function M. The function A may utilize 2.5% of the resources. The function B may utilize 4.7% of the resources. The function C may utilize 5.8% of the resources. The function D may utilize 6.8% of the resources. The function E may utilize 7.5% of resources. The function F may utilize 8.0% of the resources. The function G may utilize 8.4% of the resources. The function H may utilize 8.8% of the resources. The function I may utilize 9.1% of the resources. The function J may utilize 9.3% of the resources. The function K may utilize 9.5% of the resources. The function L may utilize 9.7% of the resources. The function M may utilize 9.8% of the resources.

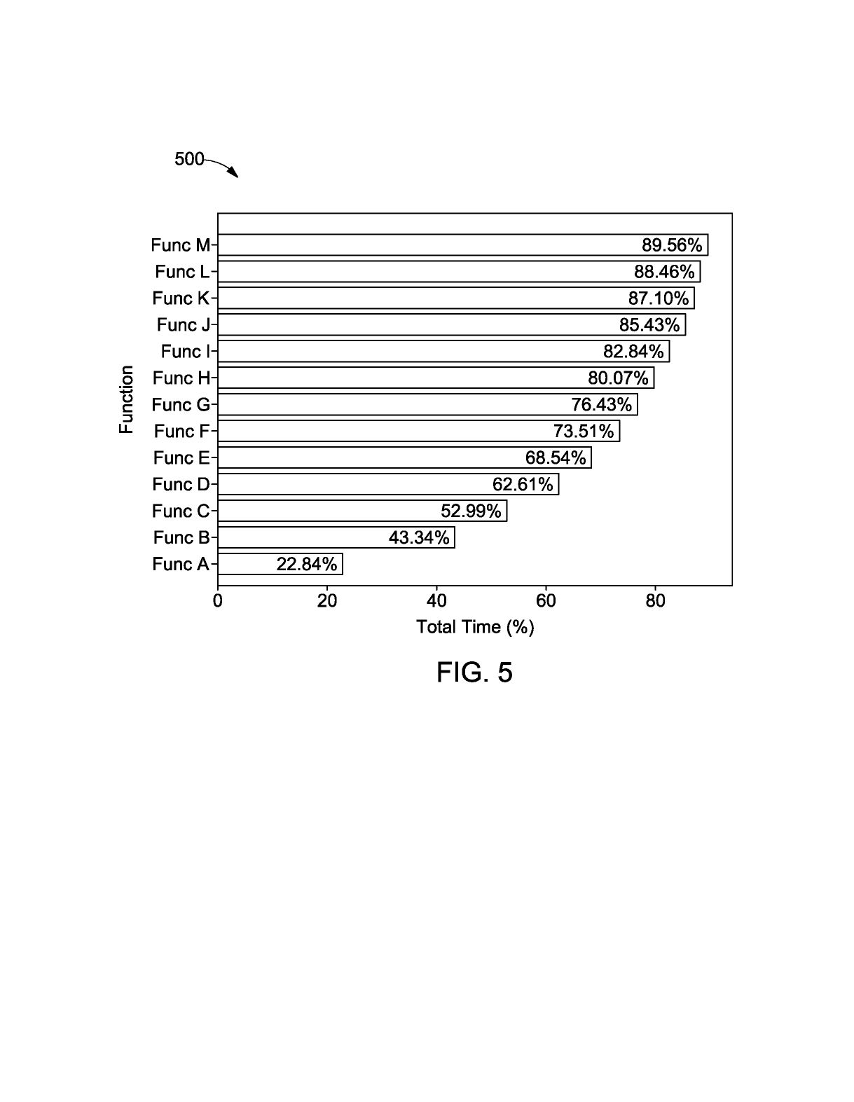

Referring now to FIG. 5, a bar graph 500 representing distribution of time spent by most consuming plurality of functions is illustrated, in accordance with an embodiment. FIG. 5 is explained in conjunction with FIGS. 1, 2, 3, and 4. FIG. 5 is explained in conjunction with FIG. 4. The bar graph 500 may be obtained from a report generating module (for example, the report generating module 206). The function A may consume 22.84% of time. The function B may consume 43.34% of time. The function C may consume 52.99% of time. The function D may consume 62.61% of time. The function E may consume 68.56% of time. The function F may consume 73.51% of time. The function G may consume 76.83% of time. The function H may consume 80.07% of time. The function I may consume 82.86% of time. The function J may consume 85.43% of time. The function K may consume 87.10% of time. The function L may consume 88.46% of time. The function M may consume 89.56% of time.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

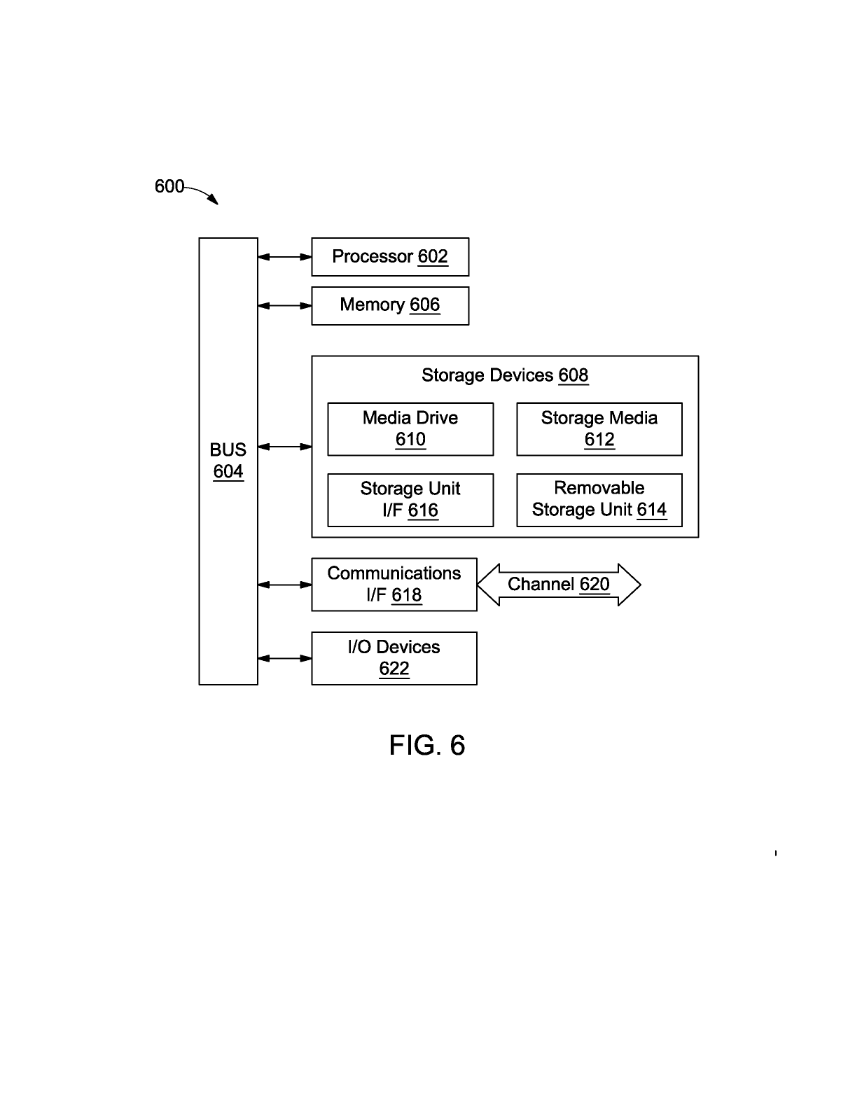

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a Graphical Processor Unit, or a Quantum Processing Unit (QPU), or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Thus, the disclosed method and system try to overcome the technical problem of profiling programs written in interpreted programming languages. The disclosed method and system may compile each of a plurality of modified functions in a source code written in an interpreted programming language using a syntax tree of the source code. Each of the plurality of modified functions is a function modified with a code-profiler. Further, the disclosed method and system may dynamically update a cache memory with each of the plurality of modified functions using a reflection technique. Further, for each of one or more threads in the source code, the disclosed method and system may capture in run-time profiling insights corresponding to the source code when the source code is executed in the cache memory. The profiling insights may include a set of function performance metrics for each of the plurality of modified functions. The profiling insights may further include a set of line performance metrics for each of a plurality of code lines in the each of the plurality of modified functions. Further, the disclosed method and system may generate a profiling report including the profiling insights corresponding to the source code.

As will be appreciated by those skilled in the art, the techniques described in the various embodiments discussed above are not routine, or conventional, or well understood in the art. The techniques may be applied across various industries where interpreted languages are used for web development, data analysis, real-time systems, and machine learning algorithms. The techniques may be used with multiple interpreted languages like Python, JavaScript, ruby, PHP, and Pearl. The techniques may include comprehensive performance insights. Comprehensive performance insights may enable detailed profiling across an entire application, helping developers to identify bottlenecks that traditional tools might miss. The techniques may include improved multi-threaded profiling. The improved multi-threaded profiling may be useful for applications that rely on concurrent processing, such as asynchronous JavaScript or Ruby’s multi-threaded web servers. The techniques may further include resource optimization. The resource optimization may include better CPU and memory management due to detailed profiling insights.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for profiling programs written in interpreted programming languages. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for profiling programs written in interpreted programming languages, the method comprising:
compiling, by a computing device, each of a plurality of modified functions in a source code written in an interpreted programming language using a syntax tree of the source code, wherein each of the plurality of modified functions is a function modified with a code-profiler;
dynamically updating, by the computing device, a cache memory with each of the plurality of modified functions using a reflection technique;
for each of one or more threads in the source code, capturing in run-time, by the computing device, profiling insights corresponding to the source code when the source code is executed in the cache memory, wherein the profiling insights comprise:
a set of function performance metrics for each of the plurality of modified functions, and
a set of line performance metrics for each of a plurality of code lines in the each of the plurality of modified functions; and
generating, by the computing device, a profiling report comprising the profiling insights corresponding to the source code.

2. The method of claim 1, further comprising receiving a user selection of a plurality of source code files through a User Interface (UI), wherein the source code comprises the plurality of source code files.

3. The method of claim 1, wherein the code-profiler is a custom decorator comprising a predefined trace function.

4. The method of claim 1, wherein compiling each of the plurality of modified functions with the code-profiler comprises:
generating a syntax tree of the source code from a plurality of source code files using a parser, wherein the syntax tree comprises a plurality of functions;
adding the code-profiler to each of the plurality of functions in the syntax tree to obtain a modified syntax tree; and
compiling the modified syntax tree into a set of low level programming instructions corresponding to the modified plurality of functions.

5. The method of claim 1, further comprising:
mapping each of the captured profiling insights with an associated function, an associated code line, and an associated thread; and
storing the mapped captured profiling insights in an associative data structure.

6. The method of claim 1, further comprising rendering the profiling report on a UI.

7. A system for profiling programs written in interpreted programming languages, the system comprising:
a processor; and
a memory communicatively coupled to the processor, wherein the memory stores processor instructions, which when executed by the processor, cause the processor to:
compile each of a plurality of modified functions in a source code written in an interpreted programming language using a syntax tree of the source code, wherein each of the plurality of modified functions is a function modified with a code-profiler;
dynamically update a cache memory with each of the plurality of modified functions using a reflection technique;
for each of one or more threads in the source code, capture in run-time profiling insights corresponding to the source code when the source code is executed in the cache memory, wherein the profiling insights comprise:
a set of function performance metrics for each of the plurality of modified functions, and
a set of line performance metrics for each of a plurality of code lines in the each of the plurality of modified functions; and
generate a profiling report comprising the profiling insights corresponding to the source code.

8. The system of claim 7, wherein the processor instructions, on execution, further cause the processor to receive a user selection of a plurality of source code files through a User Interface (UI), wherein the source code comprises the plurality of source code files.

9. The system of claim 7, wherein the code-profiler is a custom decorator comprising a predefined trace function.

10. The system of claim 7, wherein to compile each of the plurality of modified functions with the code-profiler, the processor instructions, on execution, further cause the processor to:
generate a syntax tree of the source code from a plurality of source code files using a parser, wherein the syntax tree comprises a plurality of functions;
add the code-profiler to each of the plurality of functions in the syntax tree to obtain a modified syntax tree; and
compile the modified syntax tree into a set of low level programming instructions corresponding to the modified plurality of functions.

11. The system of claim 7, wherein the processor instructions, on execution, further cause the processor to:
map each of the captured profiling insights with an associated function, an associated code line, and an associated thread; and
store the mapped captured profiling insights in an associative data structure.

12. The system of claim 7, wherein the processor instructions, on execution, further cause the processor to render the profiling report on a UI.

13. A non-transitory computer-readable medium storing computer-executable instructions for profiling programs written in interpreted programming languages, the computer-executable instructions configured for:
compiling each of a plurality of modified functions in a source code written in an interpreted programming language using a syntax tree of the source code, wherein each of the plurality of modified functions is a function modified with a code-profiler;
dynamically updating a cache memory with each of the plurality of modified functions using a reflection technique;
for each of one or more threads in the source code, capturing in run-time profiling insights corresponding to the source code when the source code is executed in the cache memory, wherein the profiling insights comprise:
a set of function performance metrics for each of the plurality of modified functions, and
a set of line performance metrics for each of a plurality of code lines in the each of the plurality of modified functions; and
generating a profiling report comprising the profiling insights corresponding to the source code.

14. The non-transitory computer-readable medium of claim 13, wherein the computer-executable instructions are further configured for receiving a user selection of a plurality of source code files through a User Interface (UI), wherein the source code comprises the plurality of source code files.

15. The non-transitory computer-readable medium of claim 13, wherein the code-profiler is a custom decorator comprising a predefined trace function.

16. The non-transitory computer-readable medium of claim 13, wherein for compiling each of the plurality of modified functions with the code-profiler, the computer-executable instructions are further configured for:
generating a syntax tree of the source code from a plurality of source code files using a parser, wherein the syntax tree comprises a plurality of functions;
adding the code-profiler to each of the plurality of functions in the syntax tree to obtain a modified syntax tree; and
compiling the modified syntax tree into a set of low level programming instructions corresponding to the modified plurality of functions.

17. The non-transitory computer-readable medium of claim 13, wherein the computer-executable instructions are further configured for:
mapping each of the captured profiling insights with an associated function, an associated code line, and an associated thread; and
storing the mapped captured profiling insights in an associative data structure.

18. The non-transitory computer-readable medium of claim 13, wherein the computer-executable instructions are further configured for rendering the profiling report on a UI.
